(19) United States
(12) Patent Application Publication
(10) Pub. No.: US 2018/0307665 A1
(43) Pub. Date: Oct. 25, 2018

(54) Computer Implemented Methods For Enhancing Word Processor Software with Third-Party Electronic Forms Design Software

(71) Applicant: Duncan James Bayne, Bury St Edmunds (GB)

(72) Inventor: Duncan James Bayne, Bury St Edmunds (GB)

(21) Appl. No.: 15/924,884

(22) Filed: Mar. 19, 2018

(30) Foreign Application Priority Data
Mar. 20, 2017 (GB) 1704411.6

(51) Int. Cl. G06F 17/24

(52) U.S. Cl. CPC G06F 17/243; G06F 3/04842

(57) ABSTRACT

The invention describes technical methods that enable word processor software to be enhanced by third-party electronic forms software, that facilitates the use of the word processor software for the design of feature-rich, interactive electronic forms that are then rendered outside of the word-processor software by the third-party software, for example as online forms within unmodified web-browsers.

### PRIORITY CLAIM

This application claims priority to Application Number 1704411.6 filed on 20 Mar. 2017 in Great Britain.

### TECHNICAL FIELD

The invention relates to the addition of third-party computer software to provide advanced interactive electronic form design and output capabilities within an existing word processing product.

### BACKGROUND OF THE INVENTION

To create interactive electronic forms (or ‘eForms’) many organisations use specialist electronic forms design software. The output of a user's design work is an electronic form specification file. The electronic form specification file specifies how the form should appear on screen, and how the fields, pages and form itself should behave as it is filled in and submitted by end users.

An electronic form specification file can be used in a number of ways, including:
The file can be used to render an interactive form within proprietary viewer/filler software.
It can be converted into an open electronic form format, for example the PDF form format, so that the form file can be opened and filled within a variety of commonly available PDF viewer/filler programs.
It can be converted into HTML form pages, with interactivity enhanced with web page scripts and server code, to be used within unmodified web-browsers. This option is most useful for distributing forms beyond niche groups of users.

However, specialist electronic forms design software has disadvantages:
It can take a long time to learn how to use.
With infrequent use, many users will fail to reach and maintain a high level of expertise.
Compared to other means of designing forms and documents, specialist forms-only design software typically produces only basic looking, unstylish forms.

Using Word Processing Software for Electronic Form Creation.

Word processing software is ubiquitous, with Microsoft Word being the most widely used program. Most regular computer users make frequent use of such software and reach a high level of competency. The typical computer user has no difficulty in creating forms within a word processor. Modern word processing software has numerous features to assist in the production of sophisticated, stylish looking form documents, typically for printing.

Common word processing software programs do have some form-filling features for on-screen use. Designers can insert form fields into a form document, and set some properties for basic interactivity. However, these are of limited use:
End users have to use the original word processing software to open and fill forms. Users without suitable software will be unable to complete forms.
The experience of using the word processor software to fill forms is not intuitive or familiar. Many users will need to follow detailed instructions of how to open the form, fill it, validate it, save it and return it.
Being a word processing file, users can edit and change the entire document. The integrity of forms is therefore difficult to maintain.

Some word processors have made limited attempts to export form documents in a format that may be used outside of the original word processor file (for example as a simple interactive PDF form). However, the inbuilt facilities of the word-processors for eForm creation are very inadequate compared to the features available with specialist eForm design software, and so little use has been made of this.

In the prior art, there are numerous standalone software products that have attempted to make use of form documents created within word processors, and then marry these with specialist eForm design software, to add advanced form filling features. Two prior art methods are:
Converting the word processor form document into an eForm design format suitable for importing into specialist eForm design software.
Using the word processor form document as the static background layer for specialist eForm design software.

Method 1: Converting a Word Processor Created Form into Specialist eForm Design Format.

Here, users create a form within the word processor software and then save this in an open file format. The standalone specialist eForm design software then loads this file, and converts it into this software's own eForm design format. This whole content of the form can then be edited, including having form fields inserted, and their properties set, within the specialist eForm design software.

The drawback with this method is that the conversion process is often imprecise, producing a flawed design, with missing or misaligned text and graphic objects. Extensive reworking of the imported word processor form usually has to be done before it is usable.

Method 2: Using a Word Processor Created Form as the Background Layer for Specialist eForm Software.

Here form documents are created within the word processor software. The completed form document is exported in an open format that strictly maintains the appearance of the document—typically the PDF format.

The specialist eForm design software then imports the form document. Once imported this becomes a static background, the content of which cannot be edited. The design user then overlays form fields above this static layer. Properties for the individual fields can be set within the eForm design software.

The final output is an electronic form specification file that contains the base layout of form pages (this is the static background document created in the word processor software), along with the properties of each of the interactive form fields, that are to be placed above the form pages.

The above method can then produce interactive forms that are a near perfect representation of the source word processor form document. With full control over the rendering of the interactive elements appearing in a layer above the form pages, powerful interactive forms can be produced.

However, the separation between (1) form background created in the word processor, and (2) the interactive field creation in the standalone eForm design software, presents a number of disadvantages:
1. Form fields have to be created twice—within the source word processor document (at least the space for fields is created), and then again, in the form field layer within the specialist form design software.
2. Changing the form requires editing of both the source word processor form file, and the form design layer. This can be time consuming. For example, the insertion of one line of text in the word processor form document, would move subsequent text, graphics and field positions on the page downwards. Each field in the overlay above the page content that had moved, would then be misaligned. These would then have to be repositioned downwards so that they are again laying above their intended positions. Even simple editing can thus become very complicated.

It is recognised that market leading word processor software packages could be developed to incorporate more useful design and export eForm capabilities, particularly for browser-based use. It must also be recognised, that over, the perhaps 20 years, in which this would have been beneficial, it has not been done in any useful way

### SUMMARY OF THE INVENTION

The invention relates to third-party software which allows electronic form design features to be incorporated within an existing word processing program.

As form documents are being designed within the word processor, custom form field objects representing form fields, can be placed within this document. The third-party software can present an interface within the word processor, so that field properties can be specified as the form document is being designed.

Whenever initiated by the user of the word processor software, both during testing and when the final form design is complete, the third-party software can generate an electronic form specification file, which in turn can used to render forms in a proprietary viewer/filler, an interactive form PDF file, or an HTML form viewed in a web-browser.

### DESCRIPTION OF THE ILLUSTRATIONS

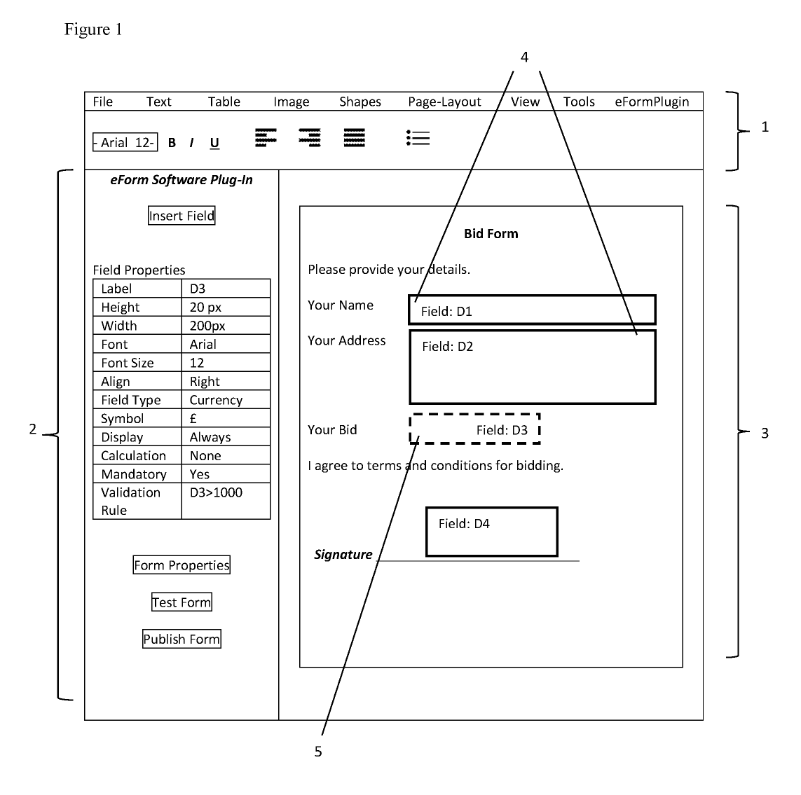

FIG. 1 shows a schematic representation of a word processor being used with third-party eForm design software during the design of an eForm.

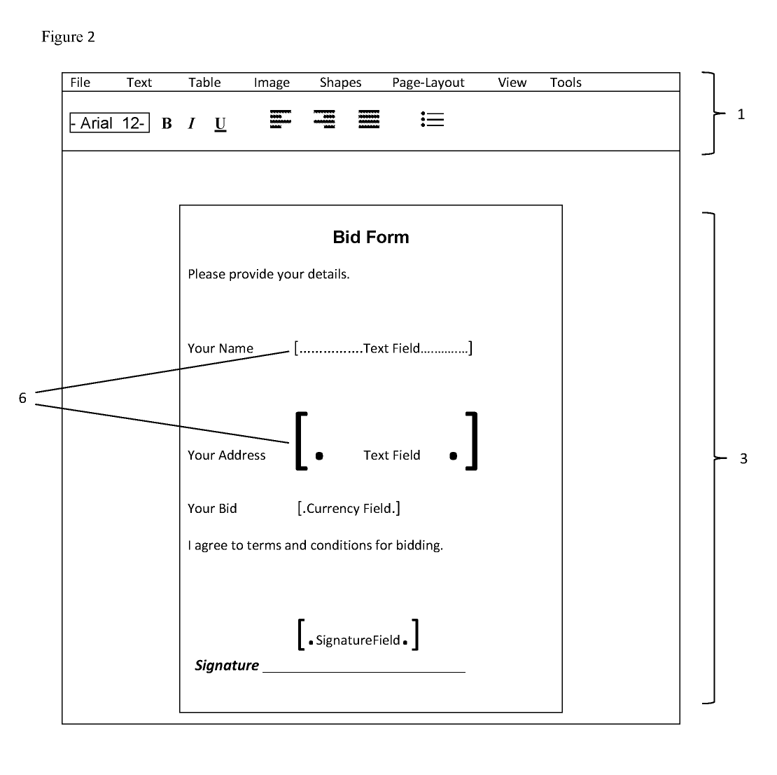

FIG. 2 shows a schematic representation of a word processor being used to create an eForm without third-party software.

### ILLUSTRATION LABELS

1. Word processor interface
2. Third-party eForm design interface
3. eForm document
4. Object representing eForm field
5. Selected field object
6. Text representing eForm form field

### DETAILED DESCRIPTION OF THE INVENTION

Most modern word processor programs—such as Microsoft Word—are designed to allow interaction with third-party programs that enhance the word processor's capabilities. Types of programmatic interaction include:
1. Embedding third-party programs (or scripts) within a document.
2. Embedding third-party program objects within a document.
3. Embedding third-party programs within the word processor interface e.g. adding additional controls that initiate functions of the third-party programs.
4. Allowing third-party programs to run as the word processor is running, with programmatic interaction with the word processor program, the document, and other programs and web-services.

In the invention (shown in FIG. 1), third party software is installed which makes use of the word processor to add enhanced eForm design capabilities for the user creating word-processor form documents.

Additional Interface

The word processor's own interface is shown (1). When installed the third party software provides an additional interface (2) to the word processor interface (1). Additional controls (2) are presented to the user when they create the form (3).

Inserting Field Objects in the Form

In the invention, on the click of a mouse or key press, a custom program object representing a field, with a unique identifier, is inserted into the document at the point at which the cursor is showing within the document (3). Alternatively, a field object could be placed into the document using a “drag and drop” method. The form fields (4) are placed in-line with the document text and other objects, and they will be treated by the word processor and behave like other objects within a placeholder, such as images, shapes, or the word processor's own form field object.

As the document is edited, if the layout of the document is rearranged, the field objects (4) will also move, along with surrounding text. These custom objects, representing fields, are an integral part of the document itself, not a layer floating above the document.

Selecting a Field

The user can select an individual custom field object with the mouse (e.g. with a click) or keyboard, the selected field is then highlighted to the user, by for example, changing the border style (5) or background colour.

When selected, the field object's precise height and width can be adjusted with key-presses.

e.g. the arrow keys can increase/reduce the height/width of the field by, for example, one pixel. Pressing these keys with another key pressed (e.g. the shift key) can result in the resizing being of greater magnitude (e.g. 10 pixels). This allows for very precise sizing of the field object within the document.

Use of graphical “hook” icons at the corners or sides of the field object, that allow the field to be made bigger/smaller by the mouse pointer dragging these “hooks” is also possible.

It is an important feature of the invention, that the field object's position, width and height can be very precisely adjusted within 1 pixel so that field objects will be perfectly placed within form documents with a complex layout.

Setting Field Properties

On selection of an individual custom field object, for example with a mouse click, the embedded third-party program (2) will display an interface listing field properties. These properties, may be edited, for example:
Field height and width (in pixels).
font type, size, colour and formatting.
Border appearance.
The data type the field is to take (e.g. text, number, droplist, Boolean, currency, date, signature, etc).
Display conditions.
Calculations and scripts that read and manipulate data entered in the field.
Validation rules and validation messages for the field data.
Field help text.

Other than the visual properties, displayed where possible, with changing the visual appearance of each third-party custom field object in the word processor document, the field properties are merely encoded as data held in memory, and will later be used to assemble a form definition file.

With no limitation on the number of properties, these may be extended to include the full range of features that third-party electronic forms software provides now or in the future.

Cutting/Copying Fields

In a feature of the invention, form properties for individual fields can be encoded as data that is stored within a data store property for the individual object representing a form field.

As a field object is cut or copied and then pasted from one part of the form document to another, or pasted into a separate document, the field properties, contained within the object will be retained. Sections of the form document, or the whole form document itself, can thus be copied/cut and pasted, without any need to re-enter the field properties, even when being copied from one document to another.

It should be noted that where each field object is given a unique identifier, then this could be used to reference field property data stored in memory outside of the field object, for example in a memory array with a record for each individual field in any open document, that can be read, managed, and written to by the third-party software that is handling the cut/copy/paste operation.

In this way field properties could be maintained as fields that are moved and copied from one part of a document to another and between documents, without field property data being stored within the object's own data store property.

Form and Page Properties

In addition to the properties that specify the behaviour of individual form fields, the invention also provides for additional properties to be set for individual pages, and the whole form, within the word processor interface enhanced by the third-party software.

Document Saving and Re-Opening.

The data encoding field, page and form properties can be stored as encoded data within the document file at the point of saving. On re-opening of the document, the third-party software can identify it as a saved form document, and can then read the encoded field, page, and form data so that the editing of the word processor form document can continue.

Note: although such data could be stored within the document file, it could also be stored elsewhere (e.g. on a webserver), and re-used with the same outcome of field, form and page property retention.

Assembling of the Electronic Form Specification File

In the invention, when initiated by the user, the third-party eForm design software running alongside and programmatically interacting with the word-processor program will assemble the electronic form specification file.

The static layout of the form can be exported as a separate file in an open format such as a PDF. This will be used to generate the background image for the rendered form. The form field objects can be removed from the PDF, to be replaced by a graphical representation of the form fields—typically a rectangle representing the field and border.

Individual field properties, page and form properties are then assembled as one data set.

In order to render the completed form, each field in the outputted form, must be placed on the precise X and Y position of the static form page as it had appeared within the word-processor document.

The invention provides for various methods for extracting this information:
1. For open documents, where the word-processor software stores the position of each custom field object on the document page, and this information is stored in memory and programmatically accessible, then this data can be read by the third-party software.
2. For open documents, where the operating system stores the X and Y position of each field on the document page, and where this data can be programmatically read by the third-party software, this data can be used.
3. Where the word-processor document is saved, if the document file contains the X and Y position of each form field, and by making each field identifiable, then the X and Y values can be read by the third-party software.
4. Where the document is saved in an open page layout format that can be opened and read programmatically, such is the case with a PDF file, the X and Y position of each field can be read from the mark-up language of the pdf, or similar file.
   With this option, before the pdf file is created, each field object within the word-processor document can be given a unique identifier, such as a label, or unique background colour (there are 16 m RGB combinations). The third-party software can then read through the pdf file, identifying each field object, and its precise location on the page, and its precise height and width, by matching its unique identifier, such as its colour, with the field in the field dataset.
5. By giving each field object a unique colour before outputting the form pages as images, the form page images can be scanned to identify rectangular blocks of pixels with the matching colours, to identify the precise positions of the individual field objects on the page.

The third-party software then has:
1. A PDF (or similar format) of the form background.
2. Details of properties of each form field.
3. The precise location, of where each field and its boundaries should appear within the form page.
4. The form and page properties.

The above information can then be combined to produce an electronic form specification file (or combination of files).

This form definition file can then be used to generate an interactive form, including generating the form with HTML and JavaScript, to be used in unmodified browsers.

The above process can be achieved within seconds of a test or publish button being initiated within the word processor.

Most usefully when the eform design has been completed, the form definition file can be sent to a webserver, and used to render eForms for viewing and filling by any number of users who can access form within an unmodified web-browser.

Saving Files and Reopening Files.

In the invention, the third-party software will embed any form, page, and field property data within the document as it is saved.

At any point, the word processor document, along with the form may be reopened, and the electronic form document edited.

Non-Integrated eForm Software

Some common word processors do not permit third party programs to have programmatic access to the word processor software or the documents being created. Also, some users with suitable word-processor software may not have access to the third-party electronic forms design software on the computer being used.

In order to get some of the advantages of the invention, in a modification, as shown in FIG. 2, simple text “objects” (6) can be placed within a word processor document (3) to represent fields. Some examples of field labels are as follows:
[.DateField.]
[.NumberField.]
[.CheckBoxField.]

The square bracket characters “[.” and “.]” are sized and placed to represent the outer borders (including the top and bottom border) of the required form field.
[. SignatureField.]

Text within the field border markers can include some basic field properties, e.g. [.NumberField*.], could represent a number field that is mandatory (mandatory is indicated by the “*”).

The word-processor document would then be exported into an open page layout format, such as a PDF file.

To create the form definition file, a program receiving the pdf file (e.g. by file upload or by email) would analyse the document mark-up, and identify where form fields should be placed (the software would look for “[.” And “.]”). Once the text block is identified, the software in the invention would then identify the location and outer boundaries of the fields on the page. The text between the brackets, would then be used as instructions about the field properties.

The third-party software then has:
1. A PDF copy of the form background (the text used to identify the placement of form fields would be removed).
2. Details of the properties of each form field.
3. The precise position, of where each field should appear within the form page.

This information, would then be sufficient to create an electronic form specification file, so that the form could be rendered for opening and filling in a specialist viewer, a PDF viewer, or a web browser.

Dynamic Document Generation

It should be noted that although the methods of the invention described concern the creation of interactive forms that a user fills in on screen, the same inventive methods can be used in the generation of customised read-only documents.

A program that receives an instruction to generate a document, along with items of data that are targeted for individual fields within the document, can use a form definition file to assemble the document, and then overlay and format the data in the precise field positions as defined in the electronic form specification file.

The result is that document templates can be created and easily edited within the word processor software also running third-party form creation software.

As well as for viewing, the same modification of the invention can be used to generate data populated documents for printing.

1. A computer implemented method of using a custom programming object representing a form field that is inserted into a document being edited within a word processor running embedded third-party eForms design software. The object is inserted in the exact position and of the size of the user's choice, where the object then behaves as an integral part of the document. The field object's position and size within the on-screen document appears precisely where the field will appear on an interactive electronic form that is subsequently rendered by the third-party electronic forms software, both on screen and when printed.

2. A computer implemented method whereby the user can select a custom programming object representing a field within a word processing document (as in claim 1) with a mouse-click or key-press. On selection, the full range of properties it will have when rendered as a feature rich electronic form by third-party software, can be viewed, and edited within a third-party forms design interface that is integrated into the word processor interface.

3. A computer implemented method whereby a word processor document with fields (as in claims 1 and 2) can be saved, with data that encodes third-party form, page and field properties being saved within the word-processor document file, so that editing of the enhanced form document can continue when the document is reopened.

4. A computer implemented method whereby a custom programming object representing a field within a word processing document (as in claim 1) has properties, set by the user (as in claim 2), encoded as data within the object's memory, allowing objects representing fields to be moved or copied from one part of a document to another, or between documents, without loss of the properties.

5. A computer implemented method where the exact position of a custom programming object representing a field within a word processing document (as in claim 1) is extracted by giving it a unique identifier, such as a unique colour, and then reading this object's precise position and boundaries, from the document exported in an open file format such as a PDF, or an image file.

6. A computer implemented method where use of text characters, such as square brackets “[ ]” are placed, and sized within a word processor document by the user to show the outer boundaries (top, bottom and sides) of the field when output as an electronic form by third-party software.
